(19) United States
(12) Patent Application Publication
(10) Pub. No.: US 2025/0272776 A1
(43) Pub. Date: Aug. 28, 2025

(54) METHOD FOR PROVIDING SERVICES WITH MULTIPLE VISUAL AGENTS WITH ARTIFICIAL INTELLIGENCE

(71) Applicant: BitHuman Inc, SAN FRANCISCO, CA (US)

(72) Inventors: Antonio Marcato, Los Angeles, CA (US); Steve Gu, Santa Clara, CA (US); Yun Fu, Newton, MA (US)

(73) Assignee: BitHuman Inc, SAN FRANCISCO, CA (US)

(21) Appl. No.: 18/589,422

(22) Filed: Feb. 28, 2024

(51) Int. Cl. G06Q 50/40

(52) U.S. Cl. CPC G06Q 50/40; G06Q 2240/00

(57) ABSTRACT

Embodiments of the present disclosure may include a method for providing services via a set of virtual agents with artificial intelligence in a service area.

### BACKGROUND OF THE INVENTION

Embodiments of the present disclosure may include a method for providing services via multiple virtual agents with artificial intelligence in a service area.

### BRIEF SUMMARY

Embodiments of the present disclosure may include a method for providing sales or services via a set of virtual agents with artificial intelligence in a service area, the method including detecting, by one or more processors, a parking request from a user with the agents with artificial intelligence. In some embodiments, the user may drive a vehicle into a garage of a mall. Embodiments may also include activating the first visual agent of the set of visual agents with artificial intelligence.

In some embodiments, the first visual agent may be configured to be a garage security personnel. In some embodiments, the first visual agent may be configured to greet the user, give a parking spot, and record the location of the parking spot. In some embodiments, the first visual agent may be configured to give directions of a first place that the user wants to visit.

In some embodiments, the set of visual agents may be empowered by an artificial intelligence engine. In some embodiments, the set of visual agents may be configured to collaborate. In some embodiments, an artificial intelligence engine may be coupled to the one or more processors and a server. In some embodiments, the artificial intelligence engine may be trained by human experts in the field.

In some embodiments, the set of virtual agents may be configured to be displayed in LED/OLED displays, Android/iOS tablets, Laptops/PCs, smartphones, or VR/AR goggles. In some embodiments, a set of multi-layer info panels coupled to the one or more processors may be configured to overlay graphics on top of the set of virtual agents. In some embodiments, any of the set of virtual agents may be configured to be displayed with an appearance of a real human or a humanoid or a cartoon character.

In some embodiments, any of the set of virtual agent's gender, age, and ethnicity may be determined by the artificial Intelligence's analysis of input from the user. In some embodiments, any of the set of virtual agents may be configured to be displayed in full-body or half-body portrait mode. In some embodiments, the artificial intelligence engine may be configured for real-time speech recognition, speech-to-text generation, real-time dialog generation, text-to-speech generation, voice-driven animation, and human avatar generation.

In some embodiments, the artificial intelligence engine may be configured to emulate different voices and use different languages. Embodiments may also include activating, at the first place, by one or more processors, a second visual agent of the set of visual agents, when the user arrives via the directions of the first place given by the first visual agent.

In some embodiments, the second visual agent may be configured to communicate with the first visual agent on the info of the user. In some embodiments, the first place may be a movie theater. In some embodiments, the second visual agent may be configured to greet and display the movie time slots and seat availability in the theater.

In some embodiments, the second visual agent may be configured to recommend movies based on the user's past choices. In some embodiments, the second visual agent may be configured to pick a time and a seat for the user for the movies based on the user's choice. In some embodiments, the second visual agent may be configured to give directions to a second place that the user wants to visit.

In some embodiments, the second visual agent may be configured to offer validation of parking tickets. Embodiments may also include activating, at the second place, by one or more processors, a third visual agent of the set of visual agents, when the user arrives via the directions of the second place given by the second visual agent. In some embodiments, the third visual agent may be configured to communicate with the first visual agent and the second visual agent on info of the user.

In some embodiments, the second place may be a restaurant. In some embodiments, the third visual agent may be configured to greet and recommend movies based on the user's past choices. In some embodiments, the third visual agent may be configured to complete the food transaction with the user. In some embodiments, the third visual agent may be configured to give directions of destination chosen by the user.

Embodiments may also include activating the first visual agent of the set of visual agents with artificial intelligence, at the garage of the mall, when the user arrives at the garage. In some embodiments, the first visual agent may be configured to recognize the user and the validated parking ticket. In some embodiments, the first visual agent may be configured to say goodbye and welcome to visit us again in the future to the user when the user drives away.

Embodiments of the present disclosure may also include a method for providing services via a set of virtual agents with artificial intelligence in a service area, the method including activating a set of visual agents at different locations with artificial intelligence sequentially. In some embodiments, any of the visual agents may be configured to greet the user.

In some embodiments, the set of visual agents may be empowered by an artificial intelligence engine. In some embodiments, the set of visual agents may be configured to collaborate with each other. In some embodiments, an artificial intelligence engine may be coupled to the one or more processors and a server. In some embodiments, the artificial intelligence engine may be trained by human experts in the field.

In some embodiments, the set of virtual agents may be configured to be displayed in LED/OLED displays, Android/iOS tablets, Laptops/PCs, smartphones, or VR/AR goggles. In some embodiments, a set of multi-layer info panels coupled to the one or more processors may be configured to overlay graphics on top of the set of virtual agents. In some embodiments, any of the set of virtual agents may be configured to be displayed with the appearance of a real human, a humanoid or a cartoon character.

In some embodiments, any of the set of virtual agent's gender, age, and ethnicity may be determined by the artificial Intelligence's analysis of input from the user. In some embodiments, any of the set of virtual agents may be configured to be displayed in full-body or half-body portrait mode. In some embodiments, the artificial intelligence engine may be configured for real-time speech recognition, speech-to-text generation, real-time dialog generation, text-to-speech generation, voice-driven animation, and human avatar generation.

In some embodiments, the artificial intelligence engine may be configured to emulate different voices and use different languages. Embodiments may also include enabling the set of visual agents at different locations with artificial intelligence sequentially to assist the user with a set of different requests. In some embodiments, the individual agent of the set of visual agents may be configured to be optimized with tasks related to business that the individual agent may be located.

Embodiments may also include enabling the set of visual agents at different locations with artificial intelligence to exchange and analyze the information of the user to better assist the user. Embodiments may also include recording interactions between the user and the set of visual agents. Embodiments may also include analyzing the interactions between the user and the set of visual agents to better assist the user in the next encounter with the user.

Embodiments of the present disclosure may also include a system for providing services via a set of virtual agents with artificial intelligence in a service area, the system including a set of visual agents at different locations with artificial intelligence sequentially. In some embodiments, any of the visual agents may be configured to greet the user.

In some embodiments, the set of visual agents may be configured to collaborate among the set of visual agents. In some embodiments, the different locations may be physical locations or digital locations. Embodiments may also include an artificial intelligence engine that may be coupled to the one or more processors a server and a set of visual agents.

In some embodiments, the set of visual agents may be empowered by the artificial intelligence engine. In some embodiments, the artificial intelligence engine may be trained by human experts in the field. In some embodiments, the set of virtual agents may be configured to be displayed in LED/OLED displays, Android/iOS tablets, Laptops/PCs, smartphones, or VR/AR goggles.

In some embodiments, a set of multi-layer info panels coupled to one or more processors may be configured to overlay graphics on top of the set of virtual agents. In some embodiments, any of the set of virtual agents may be configured to be displayed with the appearance of a real human, a humanoid or a cartoon character. In some embodiments, any of the set of virtual agent's gender, age, and ethnicity may be determined by the artificial Intelligence's analysis of input from the user.

In some embodiments, any of the set of virtual agents may be configured to be displayed in full-body or half-body portrait mode. In some embodiments, the artificial intelligence engine may be configured for real-time speech recognition, speech-to-text generation, real-time dialog generation, text-to-speech generation, voice-driven animation, and human avatar generation.

In some embodiments, the artificial intelligence engine may be configured to emulate different voices and use different languages. In some embodiments, the artificial intelligence engine may be configured to perform the following tasks enabling the set of visual agents at different locations with artificial intelligence sequentially to assist the user with a set of different requests.

In some embodiments, the individual agent of the set of visual agents may be configured to be optimized with tasks related to the business that the individual agent may be located. Embodiments may also include enabling the set of visual agents at different locations with artificial intelligence to exchange and analyze the information of the user to better assist the user. Embodiments may also include recording interactions between the user and the set of visual agents. Embodiments may also include analyzing the interactions between the user and the set of visual agents to better assist the user in the next encounter with the user.

### BRIEF DESCRIPTION OF THE FIGURES

FIG. 1 is a flowchart illustrating a method for providing services via multiple virtual agents with artificial intelligence, according to some embodiments of the present disclosure.

FIG. 2 is a flowchart illustrating a method for providing services via multiple virtual agents with artificial intelligence, according to some embodiments of the present disclosure.

FIG. 3 is a block diagram illustrating a system, according to some embodiments of the present disclosure.

FIG. 4 is a diagram showing an example of a method for providing services via multiple virtual agents with artificial intelligence, according to some embodiments of the present disclosure.

FIG. 5 is a diagram showing a second example of a method for providing embodiments of the present disclosure.

FIG. 6 is a diagram showing a third example of a method for providing services via multiple virtual agents with artificial intelligence, according to some embodiments of the present disclosure.

FIG. 7 is a diagram showing a fourth example of a method for providing services via multiple virtual agents with artificial intelligence, according to some embodiments of the present disclosure.

FIG. 8 is a diagram showing a fifth example of a method for providing services via multiple virtual agents with artificial intelligence, according to some embodiments of the present disclosure.

FIG. 9 is a diagram showing a sixth example of a method for providing services via multiple virtual agents with artificial intelligence, according to some embodiments of the present disclosure.

FIG. 10 is a diagram showing a seventh example of a method for providing services via multiple virtual agents with artificial intelligence, according to some embodiments of the present disclosure.

### DETAILED DESCRIPTION

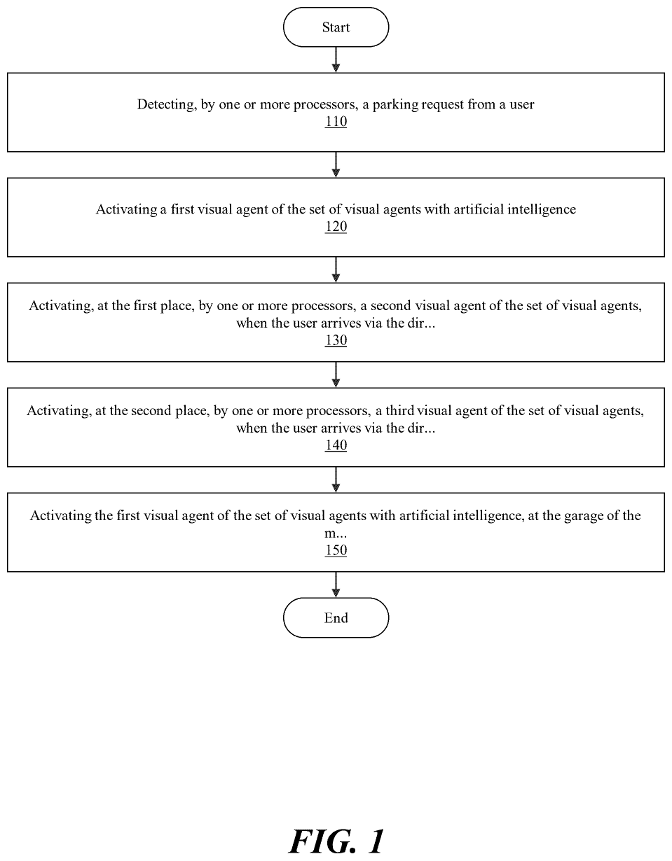

FIG. 1 is a flowchart that describes a method for providing services via multiple virtual agents with artificial intelligence, according to some embodiments of the present disclosure. In some embodiments, at 110, the method may include detecting, by one or more processors, a parking request from a user. At 120, the method may include activating a first visual agent of the set of visual agents with artificial intelligence. At 130, the method may include activating, at the first place, by one or more processors, a second visual agent of the set of visual agents, when the user arrives via the directions of the first place given by the first visual agent.

In some embodiments, at 140, the method may include activating, at the second place, by one or more processors, a third visual agent of the set of visual agents, when the user arrives via the directions of the second place given by the second visual agent. At 150, the method may include activating the first visual agent of the set of visual agents with artificial intelligence, at the garage of the mall, when the user arrives at the garage.

In some embodiments, the user may drive a vehicle into a garage of a mall. The first visual agent may be configured to be a garage security personnel. The first visual agent may be configured to greet the user, give a parking spot and record location of the parking spot. The first visual agent may be configured to give directions of a first place that the user may want to visit. The set of visual agents may be empowered by an artificial intelligence engine.

In some embodiments, the set of visual agents may be configured to collaborate with each other. An artificial intelligence engine may be coupled to the one or more processors and a server. The artificial intelligence engine may be trained by human experts in the field. The set of virtual agents may be configured to be displayed in LED/OLED displays, Android/iOS tablets, Laptops/PCs, smartphones, or VR/AR goggles. A set of multi-layer info panels coupled to the one or more processors may be configured to overlay graphics on top of the set of virtual agents.

In some embodiments, any of the set of virtual agents may be configured to be displayed with the appearance of a real human, a humanoid or a cartoon character. Any of the set of virtual agent's gender, age, and ethnicity may be determined by the artificial Intelligence's analysis of input from the user. Any of the set of virtual agents may be configured to be displayed in full-body or half-body portrait mode. The artificial intelligence engine may be configured for real-time speech recognition, speech-to-text generation, real-time dialog generation, text-to-speech generation, voice-driven animation, and human avatar generation.

In some embodiments, the artificial intelligence engine may be configured to emulate different voices and use different languages. The second visual agent may be configured to communicate with the first visual agent on the info of the user. The first place may be a movie theater. The second visual agent may be configured to greet and display the movie time slots and seat availability in the theater. The second visual agent may be configured to recommend movies based on the user's past choices.

In some embodiments, the second visual agent may be configured to pick a time and a seat for the user for the movies based on user's choice. The second visual agent may be configured to give directions to a second place that the user may want to visit. The second visual agent may be configured to offer validation of parking ticket. The third visual agent may be configured to be communicating with the first visual agent and the second visual agent on info of the user.

In some embodiments, the second place may be a restaurant. The third visual agent may be configured to greet and recommend movies based on the user's past choices. The third visual agent may be configured to complete the food transaction with the user. The third visual agent may be configured to give directions of destination chosen by the user. The first visual agent may be configured to recognize the user and the validated parking ticket. The first visual agent may be configured to say goodbye and welcome to visit us again in the future to the user when the user may drive away.

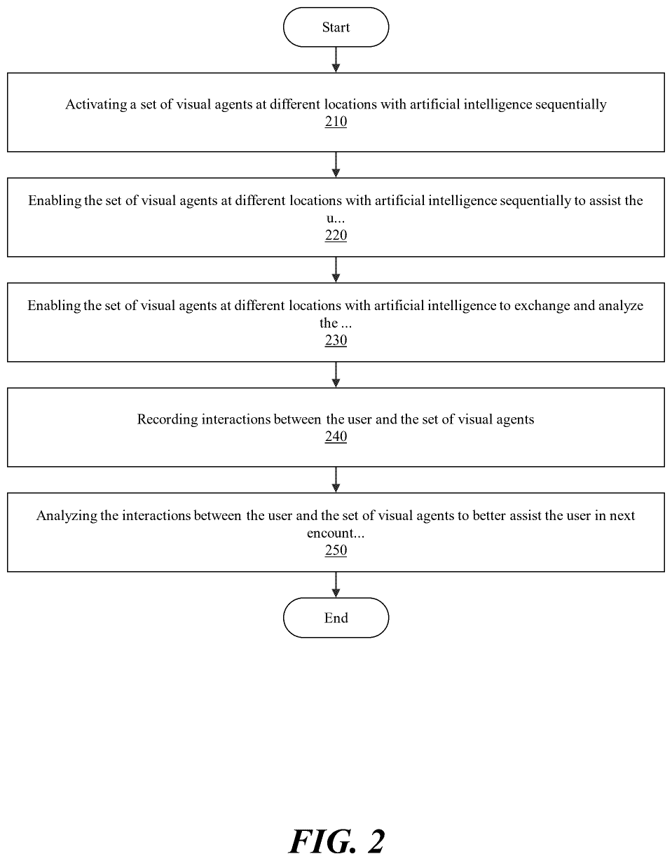

FIG. 2 is a flowchart that describes a method for providing services via multiple virtual agents with artificial intelligence, according to some embodiments of the present disclosure. In some embodiments, at 210, the method may include activating a set of visual agents at different locations with artificial intelligence sequentially. At 220, the method may include enabling the set of visual agents at different locations with artificial intelligence sequentially to assist the user with a set of different requests. At 230, the method may include enabling the set of visual agents at different locations with artificial intelligence to exchange and analyze the information of the user to better assist the user. At 240, the method may include recording interactions between the user and the set of visual agents. At 250, the method may include analyzing the interactions between the user and the set of visual agents to better assist the user in next encounter with the user.

In some embodiments, any of the visual agents may be configured to greet the user. The set of visual agents may be empowered by an artificial intelligence engine. The set of visual agents may be configured to collaborate with each other. An artificial intelligence engine may be coupled to the one or more processors and a server. The artificial intelligence engine may be trained by human experts in the field. The set of virtual agents may be configured to be displayed in LED/OLED displays, Android/iOS tablets, Laptops/PCS, smartphones, or VR/AR goggles.

In some embodiments, a set of multi-layer info panels coupled to one or more processors may be configured to overlay graphics on top of the set of virtual agents. Any of the set of virtual agents may be configured to be displayed with the appearance of a real human, a humanoid or a cartoon character. Any of the set of virtual agent's gender, age and ethnicity may be determined by the artificial Intelligence's analysis of input from the user.

In some embodiments, any of the set of virtual agents may be configured to be displayed in full-body or half-body portrait mode. The artificial intelligence engine may be configured for real-time speech recognition, speech-to-text generation, real-time dialog generation, text-to-speech generation, voice-driven animation, and human avatar generation. The artificial intelligence engine may be configured to emulate different voices and use different languages. The individual agent of the set of visual agents may be configured to be optimized with tasks related to the business that the individual agent may be located.

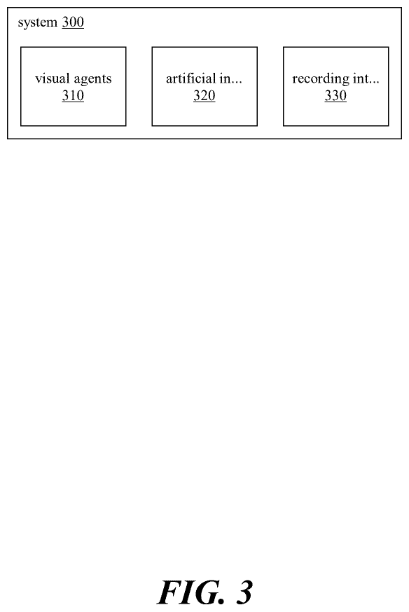

FIG. 3 is a block diagram that describes a system 300, according to some embodiments of the present disclosure. In some embodiments, the system 300 may include a set of visual agents 310 at different locations with artificial intelligence sequentially, an artificial intelligence engine 320 that may be coupled to the one or more processors and a server and the set of visual agents 310, and recording interactions 330 between the user and the set of visual agents 310. Any of the visual agents 310 may be configured to greet the user.

In some embodiments, the set of visual agents 310 may be configured to collaborate among the set of visual agents 310. The different locations may be physical locations or digital locations. The set of visual agents 310 may be empowered by the artificial intelligence engine 320. The artificial intelligence engine 320 may be trained by human experts in the field. The set of virtual agents may be configured to be displayed in LED/OLED displays, Android/iOS tablets, Laptops/PCs, smartphones, or VR/AR goggles.

In some embodiments, a set of multi-layer info panels coupled to the one or more processors may be configured to overlay graphics on top of the set of virtual agents. Any of the set of virtual agents may be configured to be displayed with the appearance of a real human or a humanoid or a cartoon character. Any of the set of virtual agent's gender, age and ethnicity may be determined by the artificial Intelligence's analysis on input from the user.

In some embodiments, any of the set of virtual agents may be configured to be displayed in full body or half body portrait mode. The artificial intelligence engine 320 may be configured for real-time speech recognition, speech-to-text generation, real-time dialog generation, text-to-speech generation, voice-driven animation, and human avatar generation. The artificial intelligence engine 320 may be configured to emulate different voices and use different languages.

In some embodiments, the artificial intelligence engine 320 may be configured to perform the following tasks: Enabling the set of visual agents 310 at different locations with artificial intelligence sequentially to assist the user with a set of different requests. The individual agent of the set of visual agents 310 may be configured to be optimized with tasks related to the business where the individual agent may be located. Enabling the set of visual agents 310 at different locations with artificial intelligence to exchange and analyze the information of the user to better assist the user. Analyzing the interactions 330 between the user and the set of visual agents 310 to better assist the user in the next encounter with the user.

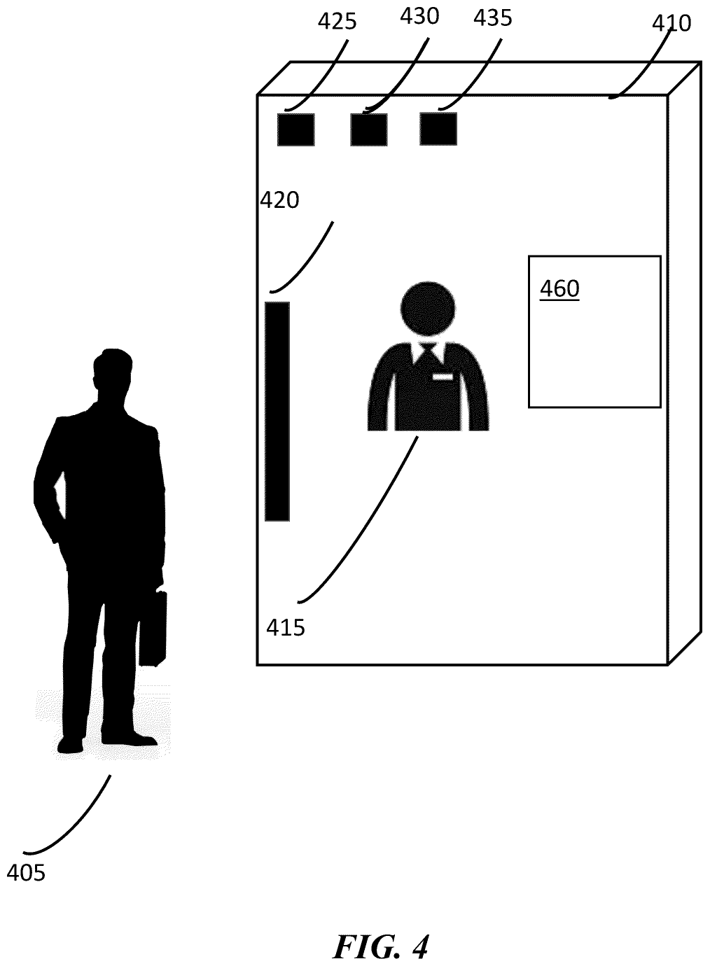

FIG. 4 is a diagram showing an example that describes a first example of a method for providing services via multiple virtual agents with artificial intelligence, according to some embodiments of the present disclosure.

In some embodiments, a user 405 can approach a smart display 410. In some embodiments, the smart display 410 could be LED or OLED-based. In some embodiments, interactive panels 420 are attached to the smart display 410. In some embodiments, camera 425, sensor 430 and microphone 435 are attached to the smart display 410. In some embodiments, an artificial intelligence visual assistant 415 is active on the smart display 410. In some embodiments, a visual working agenda 460 is shown on the smart display 410. In some embodiments, user 405 can approach the smart display 410 and initiate and complete the intended business with the visual assistant 415 by the methods described in FIG. 1-FIG. 3. In some embodiments, interactive panel 420 is coupled to a central processor. In some embodiments, interactive panel 420 is coupled to a server via a wireless link. In some embodiments, user 405 can interact with the visual assistant 415 via camera 425, sensor 430 and microphone 435 using methods described in FIG. 1-FIG. 3, with the help of interactive panel 420. In some embodiments, user 405 can choose what language to use. In some embodiments, other users can use this service described in this paragraph. In some embodiments, the user is able to interact with multiple AI visual agents as described in this example and methods described in FIG. 1-3.

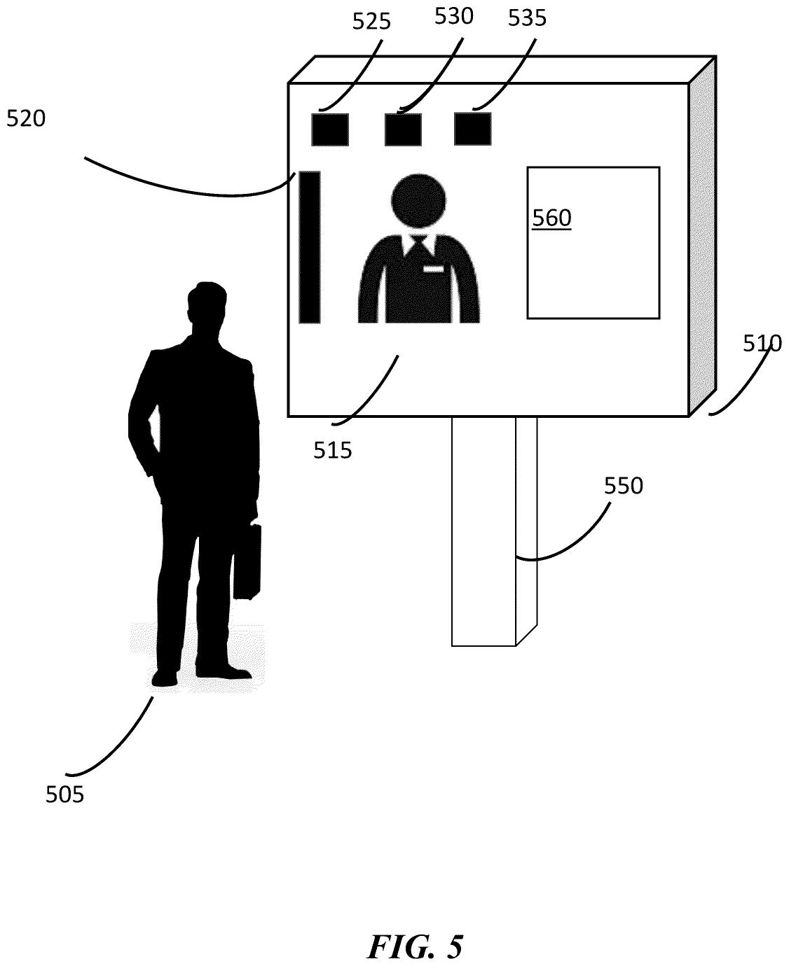

FIG. 5 is a diagram showing a second example of a method for providing embodiments of the present disclosure.

In some embodiments, a user 505 can approach a smart display 510. In some embodiments, the smart display 510 could be LED or OLED-based. In some embodiments, interactive panels 520 are attached to the smart display 510. In some embodiments, camera 525, sensor 530, and microphone 535 are attached to the smart display 510. In some embodiments, a support column 550 is attached to the smart display 510. In some embodiments, an artificial intelligence visual assistant 515 is active on the smart display 510. In some embodiments, a visual working agenda 560 is shown on the smart display 510. In some embodiments, user 505 can approach the smart display 510 and initiate and complete the business process with the visual assistant 515 by the methods described in FIG. 1-FIG. 3. In some embodiments, interactive panel 520 is coupled to a central processor. In some embodiments, interactive panel 520 is coupled to a server via a wireless link. In some embodiments, user 505 can interact with the visual assistant 515 via camera 525, sensor 530 and microphone 535 using methods described in FIG. 1-FIG. 3, with the help of interactive panel 520. In some embodiments, user 505 can choose what language to be used. In some embodiments, other users can use this service descripted in this paragraph. In some embodiments, other users can use this service described in this paragraph. In some embodiments, the user is able to interact with multiple AI visual assistants as described in this example and methods described in FIG. 1-3.

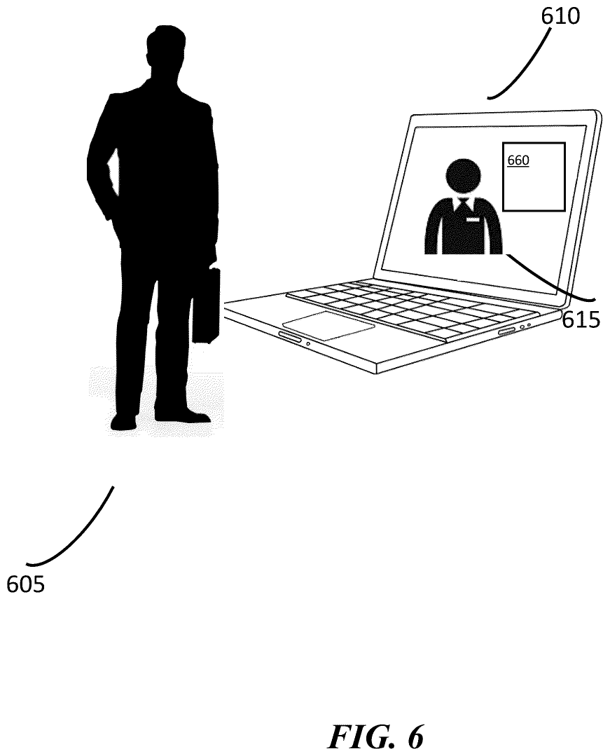

FIG. 6 is a diagram showing a third example of a method for providing services via multiple virtual agents with artificial intelligence, according to some embodiments of the present disclosure.

In some embodiments, a user 605 can approach a smart display 610. In some embodiments, the smart display 610 could be LED or OLED-based. In some embodiments, the display 610 could be a part of a desktop computer, a laptop computer or a tablet computer. In some embodiments, a camera, sensor, and microphone are attached to the smart display 610. In some embodiments, an artificial intelligence visual assistant 615 is active on the smart display 610. In some embodiments, a visual working agenda 660 is shown on the smart display 610. In some embodiments, user 605 can approach the smart display 610 and initiate and complete the business process with the visual assistant 615 by the methods described in FIG. 1-FIG. 3. In some embodiments, a keyboard is coupled to a central processor. In some embodiments, a keyboard is coupled to a server via a wireless link. In some embodiments, user 605 can interact with the visual assistant 615 via a camera, sensor and microphone using methods described in FIG. 1-FIG. 3, with the help of the keyboard. In some embodiments, user 605 can choose what language to use. In some embodiments, other users can use this service descripted in this paragraph. In some embodiments, other users can use this service described in this paragraph. In some embodiments, the user is able to interact with multiple AI visual assistants as described in this example and methods described in FIG. 1-3.

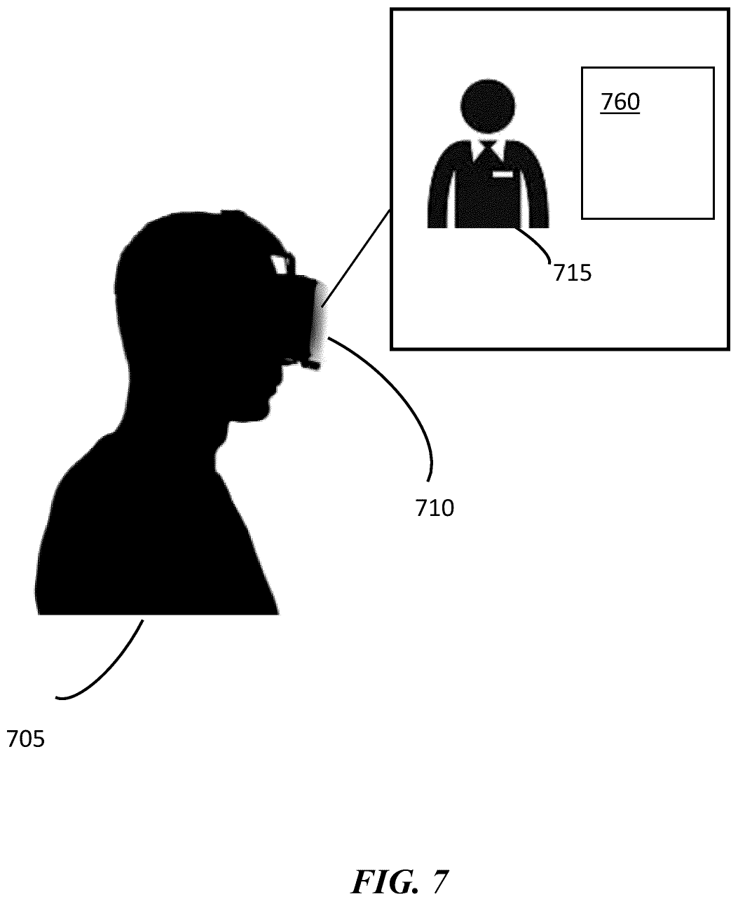

FIG. 7 is a diagram showing a fourth example of a method for providing services via multiple virtual agents with artificial intelligence, according to some embodiments of the present disclosure.

In some embodiments, a user 705 can view programs including news with a VR or AR device 710. In some embodiments, a processor and a server are connected to the VR or AR device 710. In some embodiments, an interactive keyboard is connected to the VR or AR device 710. In some embodiments, an AI visual assistant 715 is active on the VR or AR device 710. In some embodiments, a visual working agenda 760 is shown on the VR or AR 710. In some embodiments, user 705 can initiate and complete the business process with the visual assistant 705 via the VR or AR device 715 by the methods described in FIG. 1-FIG. 3. In some embodiments, an interactive panel is coupled to a central processor. In some embodiments, an interactive panel is coupled to a server via a wireless link. In some embodiments, the user 705 can choose what language to use. In some embodiments, other users can use this service descripted in this paragraph. In some embodiments, other users can use this service described in this paragraph. In some embodiments, the user is able to interact with multiple AI visual assistants as described in this example and methods described in FIG. 1-3.

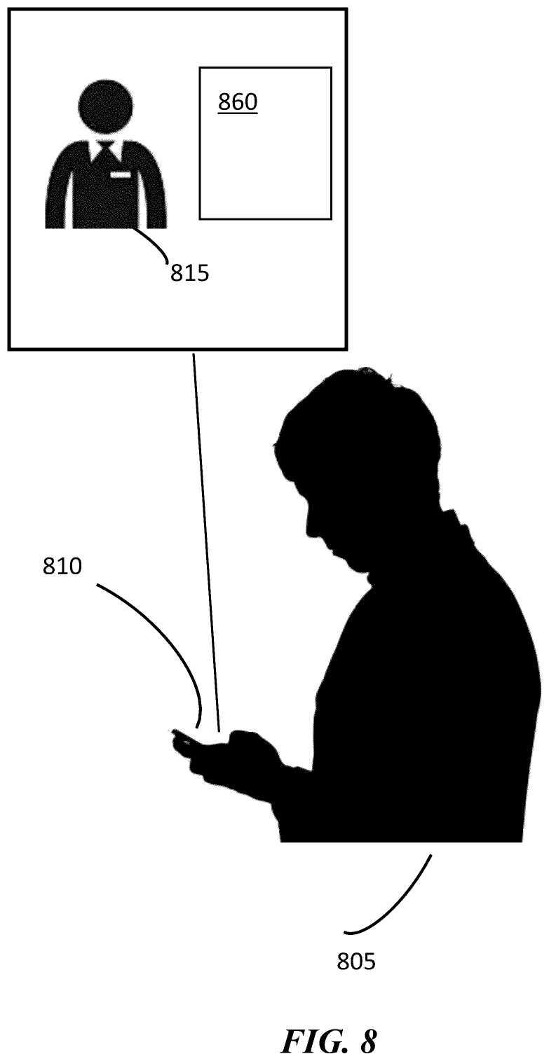

FIG. 8 is a diagram showing a fifth example of a method for providing services via multiple virtual agents with artificial intelligence, according to some embodiments of the present disclosure.

In some embodiments, a user 805 can view programs including news with a smartphone device 810. In some embodiments, a processor and a server are connected to the smartphone device 810. In some embodiments, an interactive keyboard is connected to the smartphone device 810. In some embodiments, an AI visual assistant 815 is active on the smartphone device 810. In some embodiments, a visual working agenda 860 is shown on the smartphone device 810. In some embodiments, user 805 can initiate and complete the business process with the visual assistant 815 via smartphone device 810 by the methods described in FIG. 1-FIG. 3. In some embodiments, an interactive panel is coupled to a central processor. In some embodiments, interactive panel is coupled to a server via a wireless link. In some embodiments, the user 805 can choose what language to be used. In some embodiments, other users can use this service descripted in this paragraph. In some embodiments, other users can use this service described in this paragraph. In some embodiments, the user is able to interact with multiple AI visual assistants as described in this example and methods described in FIG. 1-3.

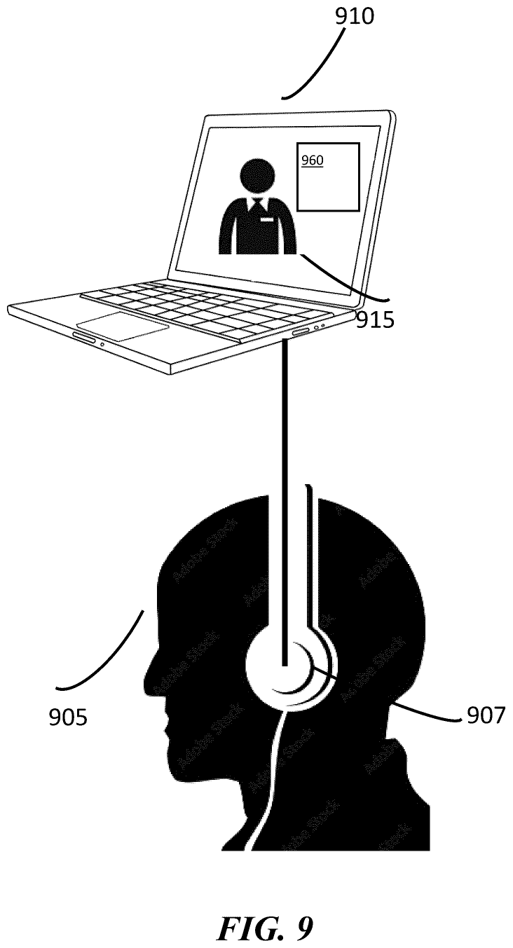

FIG. 9 is a diagram showing a sixth example of a method for providing services via multiple virtual agents with artificial intelligence, according to some embodiments of the present disclosure.

In some embodiments, a user 905 has a brain-computer interface. In some embodiments, the user 905 may wear a headset 907 that can detect and translate the electric signal from the brain and communicate with the computer or other devices. The computer 910 or other devices are connected with a cable or wire to the headset. In some embodiments, a processor and a server are connected to the computer 910. In some embodiments, an interactive keyboard is connected to the computer 910. In some embodiments, an AI visual assistant 915 is active on the computer 910. In some embodiments, a visual working agenda 960 is shown on the computer 910. In some embodiments, user 905 can initiate and complete the business process with the visual assistant 905 via the computer 915 by the methods described in FIG. 1-FIG. 3. In some embodiments, an interactive panel is coupled to a central processor. In some embodiments, an interactive panel is coupled to a server via a wireless link. In some embodiments, the user 905 can choose what language to use. In some embodiments, other users can use this service descripted in this paragraph. In some embodiments, other users can use this service described in this paragraph. In some embodiments, the user is able to interact with multiple AI visual assistants as described in this example and methods described in FIG. 1-3.

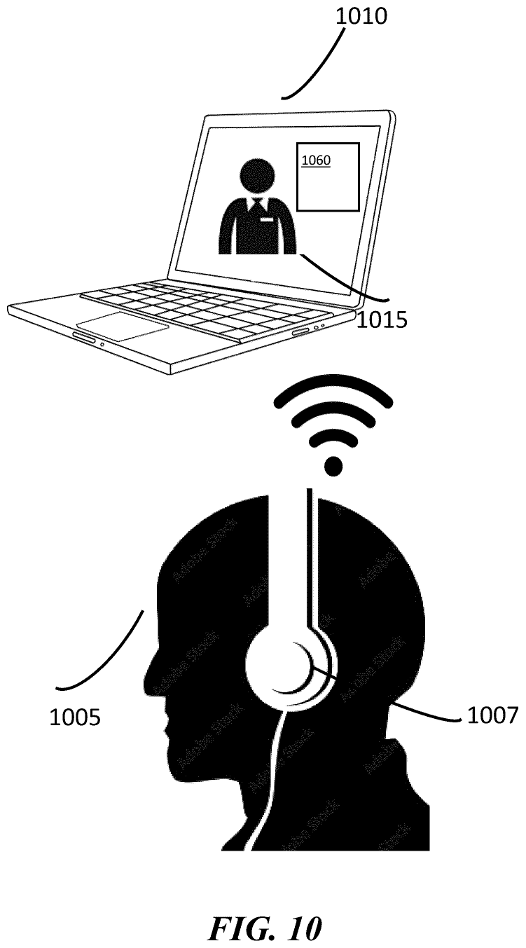

FIG. 10 is a diagram showing a seventh example of a method for providing embodiments of the present disclosure.

In some embodiments, a user 1005 has a brain-computer interface. In some embodiments, the user 1005 may wear a headset 1007 that can detect and translate the electric signal from the brain and communicate with the computer or other devices. The computer 1010 or other devices are connected with wireless means to the headset. In some embodiments, a processor and a server are connected to the computer 1010. In some embodiments, an interactive keyboard is connected to the computer 1010. In some embodiments, an AI visual assistant 1015 is active on the computer 1010. In some embodiments, a visual working agenda 1060 is shown on the computer 1010. In some embodiments, user 1005 can initiate and complete the business process with the visual assistant 1005 via the computer 1015 by the methods described in FIG. 1-FIG. 3. In some embodiments, an interactive panel is coupled to a central processor. In some embodiments, an interactive panel is coupled to a server via a wireless link. In some embodiments, the user 1005 can choose what language to use. In some embodiments, other users can use this service descripted in this paragraph. In some embodiments, other users can use this service described in this paragraph. In some embodiments, the user is able to interact with multiple AI visual assistants as described in this example and methods described in FIG. 1-3.

1. A method for providing services via a set of virtual agents with artificial intelligence in a service area, the method comprising:
detecting, by one or more processors, a parking request from a user, wherein the user may drive a vehicle into a garage of a mall;
activating a first visual agent of the set of visual agents with artificial intelligence, wherein the first visual agent is configured to be a garage security personnel, wherein the first visual agent is configured to greet the user, give a parking spot and record location of the parking spot, wherein the first visual agent is configured to give directions of a first place that the user wants to visit, wherein the set of visual agents are empowered by an artificial intelligence engine, wherein the set of visual agents are configured to collaborate with each other, wherein an artificial intelligence engine is coupled to the one or more processors and a server, wherein the artificial intelligence engine is trained by human experts in the field, wherein the set of virtual agents are configured to be displayed in LED/OLED displays, Android/iOS tablets, Laptops/PCs, smartphones, or VWAR goggles, wherein a set of multi-layer info panels coupled to the one or more processors are configured to overlay graphics on top of the set of virtual agents, wherein any of the set of virtual agents are configured to be displayed with an appearance of a real human or a humanoid or a cartoon character, wherein any of the set of virtual agents' gender, age and ethnicity is determined by the artificial Intelligence's analysis on input from the user, wherein any of the set of virtual agents is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages;
activating, at the first place, by one or more processors, a second visual agent of the set of visual agents, when the user arrives via the directions of the first place given by the first visual agent, wherein the second visual agent is configured to be communicating with the first visual agent on info of the user, wherein the first place is a movie theater, wherein the second visual agent is configured to greet and display the movie time slots and seat availability in the theater, wherein the second visual agent is configured to recommend movies based on the users' past choices, wherein the second visual agent is configured to pick a time and a seat for the user for the movies based on user's choice, wherein the second visual agent is configured to give directions to a second place that the user wants to visit, wherein the second visual agent is configured to offer validation of parking ticket;
activating, at the second place, by one or more processors, a third visual agent of the set of visual agents, when the user arrives via the directions of the second place given by the second visual agent, wherein the third visual agent is configured to be communicating with the first visual agent and the second visual agent on info of the user, wherein the second place is a restaurant, wherein the third visual agent is configured to greet and recommend movies based on the users' past choices, wherein the third visual agent is configured to complete the food transaction with the user, wherein the third visual agent is configured to give directions of destination chosen by the user; and
activating the first visual agent of the set of visual agents with artificial intelligence, at the garage of the mall, when the user arrives at the garage, wherein the first visual agent is configured to recognize the user and the validated parking ticket, wherein the first visual agent is configured to say goodbye and welcome to visit us again in the future to the user when the user drives away.

2. A method for providing services via a set of virtual agents with artificial intelligence in a service area, the method comprising:
activating a set of visual agents at different locations with artificial intelligence sequentially, wherein any of the visual agents arc configured to greet the user, wherein the set of visual agents arc empowered by an artificial intelligence engine, wherein the set of visual agents arc configured to collaborate with each other, wherein an artificial intelligence engine is coupled to the one or more processors and a server, wherein the artificial intelligence engine is trained by human experts in the field, wherein the set of virtual agents are configured to be displayed in LED/OLED displays, Android/iOS tablets, Laptops/PCs, smartphones, or VR/AR goggles, wherein a set of multi-layer info panels coupled to the one or more processors are configured to overlay graphics on top of the set of virtual agents, wherein any of the set of virtual agents are configured to be displayed with an appearance of a real human or a humanoid or a cartoon character, wherein any of the set of virtual agents' gender, age and ethnicity is determined by the artificial Intelligence's analysis on input from the user, wherein any of the set of virtual agents is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages, wherein the set of visual agents are configured to collaborate with each other;
enabling the set of visual agents at different locations with artificial intelligence sequentially to assist the user with a set of different requests, wherein the individual agent of the set of visual agents is configured to be optimized with tasks related to business that the individual agent is located;
enabling the set of visual agents at different locations with artificial intelligence to exchange and analyze the information of the user to better assist the user;
recording interactions between the user and the set of visual agents; and
analyzing the interactions between the user and the set of visual agents to better assist the user in next encounter with the user.

3. A system for providing services via a set of virtual agents with artificial intelligence in a service area, the system comprising:
a set of visual agents at different locations with artificial intelligence sequentially, wherein any of the visual agents are configured to greet the user, wherein the set of visual agents are configured to collaborate among the set of visual agents, wherein the different locations are physical locations or digital locations, wherein the set visual agents are configured to collaborate with each other;
an artificial intelligence engine that is coupled to the one or more processors and a server and the set of visual agents, wherein the set of visual agents are empowered by the artificial intelligence engine, wherein the artificial intelligence engine is trained by human experts in the field, wherein the set of virtual agents are configured to be displayed in LED/OLED displays, Android/iOS tablets, Laptops/PCs, smartphones, or VR/AR goggles, wherein a set of multi-layer info panels coupled to the one or more processors are configured to overlay graphics on top of the set of virtual agents, wherein any of the set of virtual agents are configured to be displayed with an appearance of a real human or a humanoid or a cartoon character, wherein any of the set of virtual agents' gender, age and ethnicity is determined by the artificial Intelligence's analysis on input from the user, wherein any of the set of virtual agents is configured to be displayed in full body or half body portrait mode, wherein the artificial intelligence engine is configured for real-time speech recognition, speech to text generation, real-time dialog generation, text to speech generation, voice-driven animation, and human avatar generation, wherein the artificial intelligence engine is configured to emulate different voices and use different languages, wherein the artificial intelligence engine is configured to perform following tasks:
enabling the set of visual agents at different locations with artificial intelligence sequentially to assist the user with a set of different requests, wherein the individual agent of the set of visual agents is configured to be optimized with tasks related to business that the individual agent is located;
enabling the set of visual agents at different locations with artificial intelligence to exchange and analyze the information of the user to better assist the user;
recording interactions between the user and the set of visual agents; and
analyzing the interactions between the user and the set of visual agents to better assist the user in next encounter with the user.
